(19) United States
(12) Patent Application Publication
(10) Pub. No.: US 2011/0221206 A1
(43) Pub. Date: Sep. 15, 2011

(54) LINEAR POWER GENERATOR WITH A RECIPROCATING PISTON CONFIGURATION

(76) Inventors: MIRO MILINKOVIC, Acton (CA); GIAN L. VASCOTTO, Thedford (CA)

(21) Appl. No.: 12/722,036

(22) Filed: Mar. 11, 2010

(51) Int. Cl. H02K 7/18; F03G 7/00; F01K 13/02

(52) U.S. Cl. 290/1 R; 60/641.2; 60/660

(57) ABSTRACT

A linear power generator for generating electrical power utilizing a waste or low grade heat source. According to an embodiment, the linear power generator comprises a cylinder assembly and an electromagnetic coil. The cylinder assembly comprises two chambers with respective pistons in a coaxial arrangement and the pistons are configured to move in opposite directions in response to the application of pressurized vapour or gas. The vapour or gas is heated utilizing the waste or low grade heat source and pressurized for the cylinder assembly. Each of the pistons includes a drive shaft which is coupled to an electromagnetic component. The pressurized vapour or gas is applied in a substantially synchronized manner to each of the chambers to move the pistons through substantially equal but opposite linear cycles. The movement of the pistons moves the electromagnetic components through the electromagnetic coil, which induces a voltage in the coil.

### FIELD OF THE INVENTION

The present invention relates to power generators, and more particularly, to a linear power generator with a reciprocating piston configuration.

### BACKGROUND OF THE INVENTION

Power generators based on the Rankine cycle typically experience significant losses arising from the conversion of expanding gases into rotary power. One approach involves using free-piston based systems. While a free-piston based system allows some of the mechanical losses to be recovered, the movement of the pistons can cause significant vibration, especially in generator systems operating at high cycle speeds and/or temperatures. The loss of energy at the end of each piston cycle and therefore reduced efficiency has also limited the wide spread application of Rankine cycle based generators.

Accordingly, there remains a need for improvements in the art.

### BRIEF SUMMARY OF THE INVENTION

The present invention comprises embodiments of a power generator with a dual free-piston configuration.

According to an embodiment, the present invention provides a power generator for generating electrical power from waste heat.

According to another embodiment, the present invention provides a method for generating electrical power from waste heat.

According to another embodiment, the present invention provides a reciprocating piston configuration for a Rankine cycle based power generator.

According to a first aspect, there is provided a linear power generator comprising: a cylinder assembly; an electromagnetic coil; the cylinder assembly comprising a first piston and a second piston configured in a substantially co-axial arrangement, the first piston being configured to move in a first direction in response to application of a pressurized gas, and the second piston being configured to move in a second direction in response to application of a pressurized gas, and the second direction being substantially opposite to the first direction; a first drive shaft coupled to said the piston at one end and having another end configured for coupling to an electromagnetic component, and the first drive shaft being configured to move the electromagnetic component in relation to the electromagnetic coil in response to movement of the first piston so as to induce a voltage in the electromagnetic coil; a second drive shaft coupled to the second piston at one end and having another end configured for coupling to an electromagnetic component, and the second drive shaft being configured to move the electromagnetic component in relation to the electromagnetic coil in response to movement of the second piston so as to induce a voltage in the electromagnetic coil; and a first rebound mechanism configured to move the first piston back to a starting position, and a second rebound mechanism configured to move the second piston back to a starting position.

According to another aspect, there is provided a method for generating power from a linear power generator utilizing a waste heat source, the method comprising: utilizing heat from the waste heat source to generate a pressurized vapour; applying a portion of the pressurized vapour to move a first piston in a linear cycle, and applying a portion of the pressurized vapour to move a second piston in a linear cycle, wherein movement of the first piston during the linear cycle is substantially opposite in direction to movement of the second piston during the linear cycle, and the first piston including a drive shaft with an electromagnetic component and the second piston including a drive shaft with an electromagnetic component; moving the electromagnetic component and the second electromagnetic component through an electromagnetic coil during at least a portion of the linear cycles to induce a voltage in the electromagnetic coil; and reversing movement of the first piston during said linear cycle to return the first piston to a starting position, and reversing movement of the second piston during the linear cycle to return the second piston to a starting position.

Other aspects and features according to the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments according to the present invention, and in which:

FIG. 1(a) shows a linear power generator according to an embodiment of the present invention;

FIG. 1(b) is a sectional view of the linear power generator of FIG. 1(a) taken along the line A-A;

FIG. 2(a) shows a linear power generator according to another embodiment of the present invention;

FIG. 2(b) is a sectional view of the linear power generator of FIG. 2(a) taken along the line A-A;

FIG. 3(a) shows a piston module for the linear power generator of FIG. 2 according to an embodiment of the invention;

FIG. 3(b) is another view of the piston module of FIG. 3(a) shown with the end or mounting plate removed;

FIG. 3(c) is an end view of the piston module of FIG. 3(b);

FIG. 4 shows a process for controlling the linear power generator according to an embodiment of the invention;

FIG. 5 shows in diagrammatic form operation of the linear power generator of FIG. 1 according to an embodiment of the present invention; and

FIG. 6 shows in diagrammatic form operation of the linear power generator of FIG. 1 according to an embodiment of the present invention.

Like reference numerals indicate like or corresponding elements in the drawings.

### DETAILED DESCRIPTION OF THE EMBODIMENTS

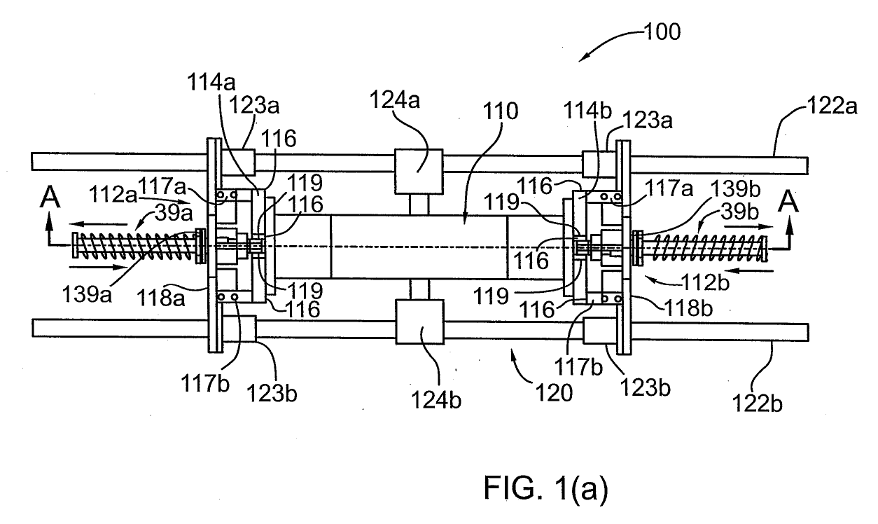

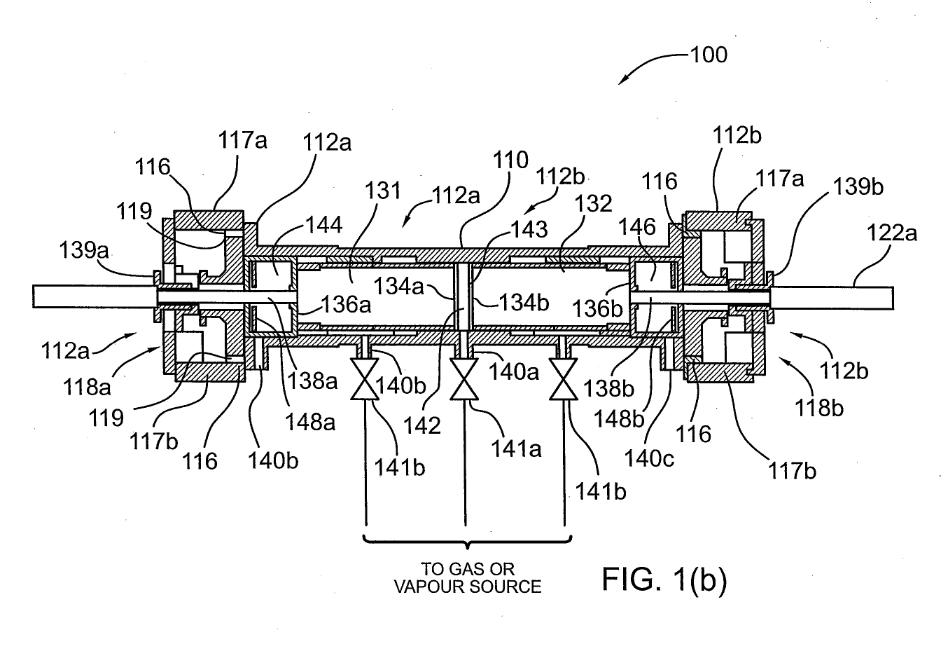

Reference is first made to FIGS. 1(a) and 1(b), which show a linear power generator according to an embodiment of the invention. The linear power generator is indicated generally by reference 100 and comprises a cylinder assembly or module 110 and a support frame 120. According to an embodiment, the support frame 120 comprises two mounting members or shafts 122, indicated individually by references 122a and 122b in FIG. 1(a).

As shown in FIG. 1(a), the cylinder assembly 110 includes respective cylinder components or modules 112, indicated individually by references 112a and 112b. The cylinder modules comprise respective cylinder flange covers 114a, 114b which are coupled to the respective ends of the cylinder assembly 110. As shown in FIGS. 1(a) and 1(b), the cylinder flange covers 114 include four slots 116. Each of the slots 116 is configured to receive or mount in each a guide pin or shaft 117. The guide pins 117 couple the respective cylinder flange cover 114 to an end bracket 118 (indicated individually by references 118a and 118b) on the cylinder assembly 110. According to an embodiment the cylinder flange cover 114 is configured with four of the slots 116 and four guide pins 117 couple to connect to the respective end brackets. According to an embodiment, the slots 116 are configured to accommodate expansion, i.e. thermal expansion, of the cylinder end assemblies 112, and include thermal insulators indicated by reference 119, to minimize heat losses from the cylinder assembly 110. The end brackets 118 couple the cylinder modules 114 to the mounting shafts 122. According to an embodiment, the end brackets 118 include mounting sleeves or collars 123 (indicated individually by references 123a and 123b) which fit the mounting shafts 122. According to an embodiment, the mounting collars 123 include a thermal barrier to minimize heat losses from the cylinder assembly 110. As shown in FIG. 1(a), the cylinder assembly 110 can also include side mounting pins or brackets 124, indicated individually by references 124a and 124b, for securing or mounting the cylinder assembly 110 to the support frame 120. The side mounting pins 124 are located along the side of cylinder assembly 110, example, at a midway point. According to an embodiment, the side mounting brackets 124 include or incorporate a thermal barrier to minimize heat losses from the cylinder assembly 110. According to another aspect, the configuration of the parallel mounting shafts 122 provides an arrangement that facilitates the mounting of other components of the system, such as the electromagnetic coil assemblies.

Reference is next made to FIG. 1(b), which shows the cylinder assembly 110 in more detail in a sectional view taken along line A-A. According to an embodiment, the cylinder assembly 110 comprises a first piston 131 and a second piston 132 configured in a coaxial or in-line arrangement. As will be described in more detail below, the movement of the pistons 131, 132 for example due to thermal expansion are equal but in opposing directions. According to an embodiment, the cylinder assembly 110 is also coupled to the respective mounting shafts 122 with the cylinder mounting pins or brackets 124, indicated individually by references 124a and 124b. Each of the pistons 131, 132 include an inside face 134 indicated individually by references 134a, 134b and an outside face, indicated individually by references 136a, 136b. The respective outside faces 136 of the pistons 131, 132 are coupled or connected to one end of a piston shaft 138, indicated individually by references 138a, 138b. The other end of the piston shafts 138 include a coupler or connector 139, indicated individually by references 139a and 139b, which is configured to connect to respective inductive elements 39, indicated individually by references 39a and 39b. According to an embodiment, the inductive element 39 may comprise a magnet which induces a voltage in a coil in response to movement of the piston, as described in more detail below.

Referring again to FIG. 1(b), the cylinder assembly 110 includes a first input/output port 140a, a second input/output port 140b and a third input/output port 140c. The first input/output port 140a is in communication with a middle chamber 142 between the inside faces 134a, 134b of the pistons 131, 132, as shown in FIG. 1(b). According to an embodiment, the middle chamber 142 is divided using a spacer indicated generally by reference 143. The second input/output port 140b is in communication with an end chamber 144 adjacent the outside face 136a of the first piston 131. Similarly, the third input/output port 140c is in communication with an end chamber 146 adjacent the outside face 136b of the second piston 132. According to an embodiment, the cylinder assembly 112a includes a rebound device 148a in the end chamber 144. The rebound device 148 is configured to repel or push back the piston 131 and prevent the piston 131 from contacting the end wall of the chamber 144 as it travels into the end chamber 144, and also to assist in reversing the direction of the travel of the piston. According to an embodiment, the rebound device 148 comprises a magnet or magnetic device which repels the moving piston 131. Similarly, the second cylinder assembly 112b includes a respective rebound device 148b which is configured to repel the piston 132.

According to an embodiment and as shown in FIG. 1(b), each of the input/output ports 140 is coupled or connected to a respective flow control switch 141, indicated individually by references 141a, 141b, 141c. According to an embodiment, the flow control switches 141 are configured as close as possible to the respective input/output ports 140 to minimize the formation of parasitic volume(s). The flow control switches 141 are coupled to a gas or vapour (or heated liquid source) and operate under the control of a controller, for example, through stepper motors controlled by a controller (e.g. microprocessor) operating under stored program control. The controller is configured to open and close the flow switches 141 in synchronization or sequence so that gas or vapour is injected and exhausted from the respective chambers to cause the pistons 131, 132 to move in a linear cycle and drive the respective inductive components 39 (for example, as indicated by arrows 133 and 135 in FIG. 1(a)) through the electromagnetic coil assemblies to generate electrical energy, as will be described in more detail below. According to an embodiment, each of the pistons 131, 132 (or piston rods) can include a motion sensor (e.g. a laser motion sensor) to monitor the position of the piston and provide a location reading that can be used to further control operation of the linear generator 100. According to an embodiment, a gas is injected into the middle chamber 142, and expansion of the gas forces the pistons 131, 132 to move away from each other and outwardly into the respective end chambers 144, 146. The two rebounding devices 148 act to force the pistons 131, 132 back to their starting positions, or with the aid of gas injected into the respective end chambers 144, 146, and through the operation of the flow valves 140b, 140c energy can be recovered from the respective end chambers 140b and 140c. The exemplary operation of the linear generator 100 in a power generation application and according to an embodiment of the invention is described in more detail below.

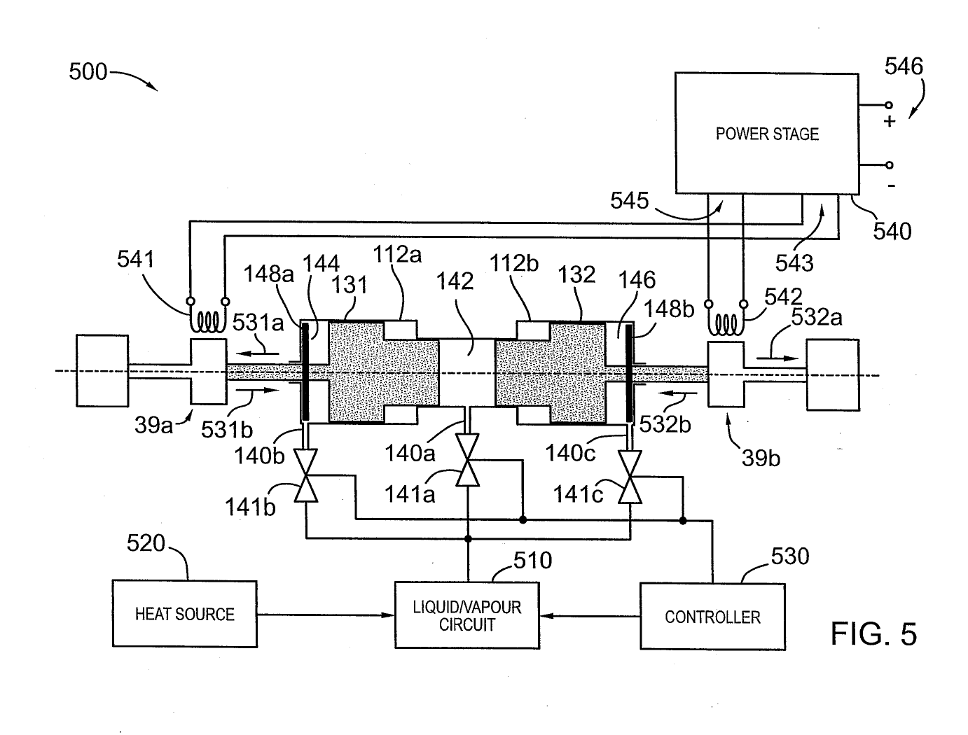

Reference is next made to FIG. 5, which shows an exemplary power generating application according to an embodiment of the invention utilizing the linear power generator 100 of FIG. 1 and indicated generally by reference 500. As shown, the power generator application 500 comprises a liquid/vapour circuit 510, a heat source 520, a controller 530 and a power stage 540. The linear power generator 100 comprises the configuration described above with reference to FIGS. 1(a) and 1(b), and like reference numerals indicate like elements. As shown, the input/ports 140 are coupled to the vapour circuit 510 via the respective flow switches 141. As shown, the vapour circuit 510 also includes an input for receiving heat energy from the heat source 520. The control inputs of the flow control switches 141 are coupled to a control port or ports on the controller 530. As also shown, the power stage 540 includes a first inductive coil 541 which is coupled to a first input port 543 and a second inductive coil 542, which is coupled to a second input port 545. According to an embodiment, the heat source 520 comprises a low grade or waste heat source. Examples of waste heat sources include internal combustion engines, HVAC equipment, electric motors, generators, waste cooling or heating liquid or geothermal sources.

According to an embodiment, the liquid/vapour circuit 510 comprises a vapourizer, an expander, a condenser and a liquid reservoir configured in a vapour-liquid heat transfer circuit. The vapour circuit 510 is configured is to produce a gas or vapour which is outputted to the linear generator 100 via the flow switches 141 and under the control of the controller 530 used to generate forces to actuate the linear power generator 100 and generate electrical power as described in more detail below. According to an embodiment, the reservoir is configured as a holding tank for a fluid or condensate, for example, a suitable Freon gas. The vapourizer includes a heat exchanger and is configured to receive low grade or waste heat from the heat source 520. The vapourizer receives fluid or condensate from the reservoir which is converted into a gas or vapour through application of the heat from the heat source 520. The resulting gas or vapour is applied to the middle chamber 142 of the linear power generator 100 via the flow control switches 141 operating under the control of the controller 530. This results in forces that drive the pistons 131, 132 in opposite directions and thereby move the inductive elements 39a, 39b across the respective coils 541, 542 as indicated by arrows 531a and 532a. As the pistons 131, 132 approach the end of the outer chambers 144, 146, the rebound devices 148a, 148b function to slow down and reverse the direction of the respective pistons 131, 132 and cause the respective coils 541, 542 to move back in the directions as indicated by arrows 531b and 532b. According to an embodiment, the inductive elements 39a and 39b comprise magnets or a magnetic coil and the movement of the inductive elements 39a, 39b induces a voltage in the respective coils 541, 542. The power stage 530 is configured to condition or otherwise process the outputs from the coils 541, 542 and produce an output at an output port 546. According to an embodiment, the power stage 530 is configured to rectify the output voltages from the coils 39a, 39b produce a DC voltage output at the output port 546.

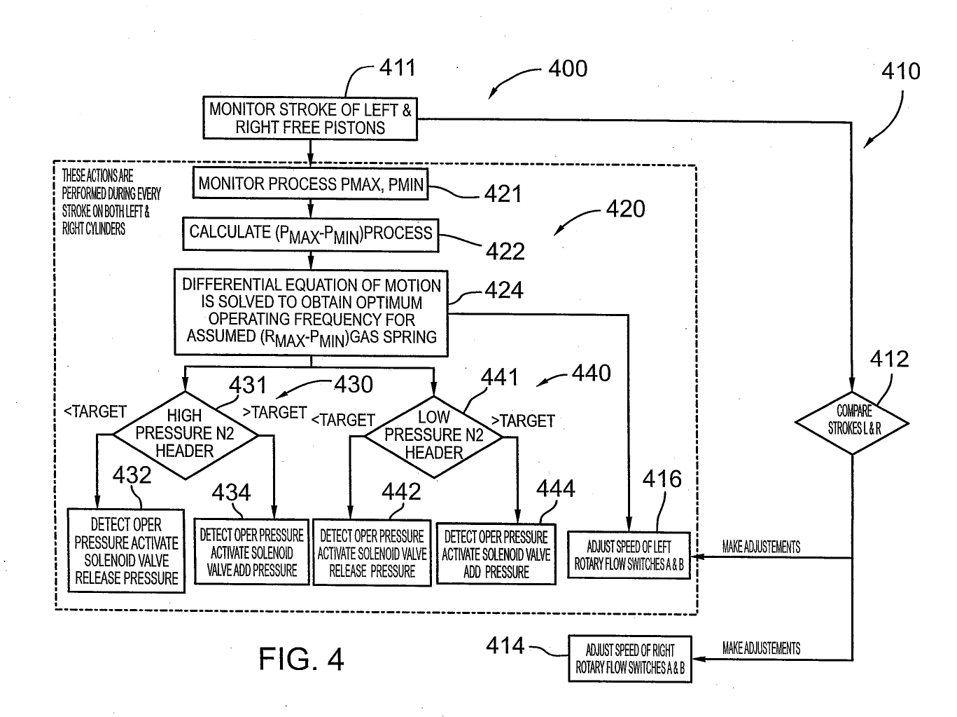

Referring again to FIG. 5, the controller 530 is configured according to an embodiment with one or more microprocessors or microcontrollers or similar programmable control devices. The microprocessor(s) in the controller 530 operate under stored program control (for example, execute instructions, executable code, programs or code modules in the form of firmware or software stored in memory) to sequentially control the opening and closing of the flow control switches 141 and the routing of vapour to/from the respective chambers 142, 144, 146 to/from the vapour circuit 510 in synchronization with the movement of the pistons 131, 132. Control functions associated with the controller 530 are described in more detail below and with reference to FIG. 4.

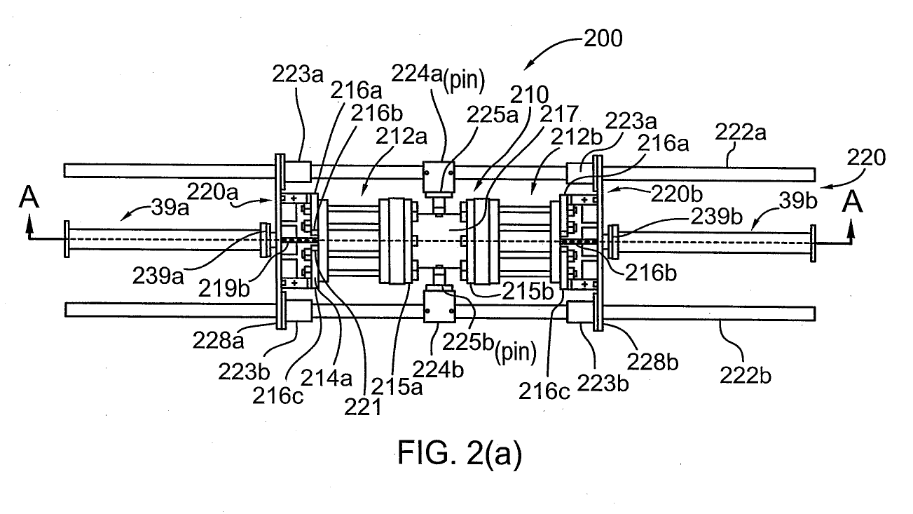

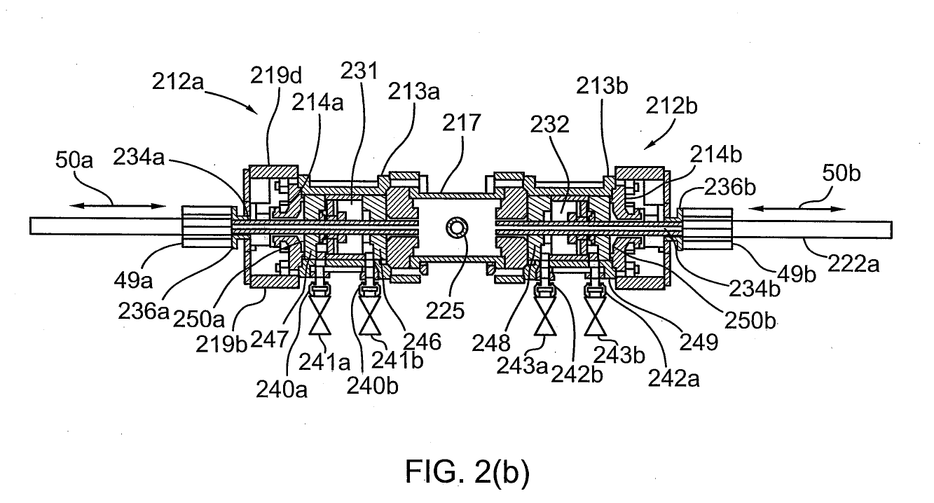

Reference is next made to FIGS. 2(a) and 2(b), which shows a linear power generator according to another embodiment of the invention, and indicated generally by reference 200. The linear power generator 200 comprises a cylinder assembly or module 210 and a support frame 220. According to an embodiment, the support frame 220 comprises two mounting members or shafts 222, indicated individually by references 222a and 222b in FIG. 2(a).

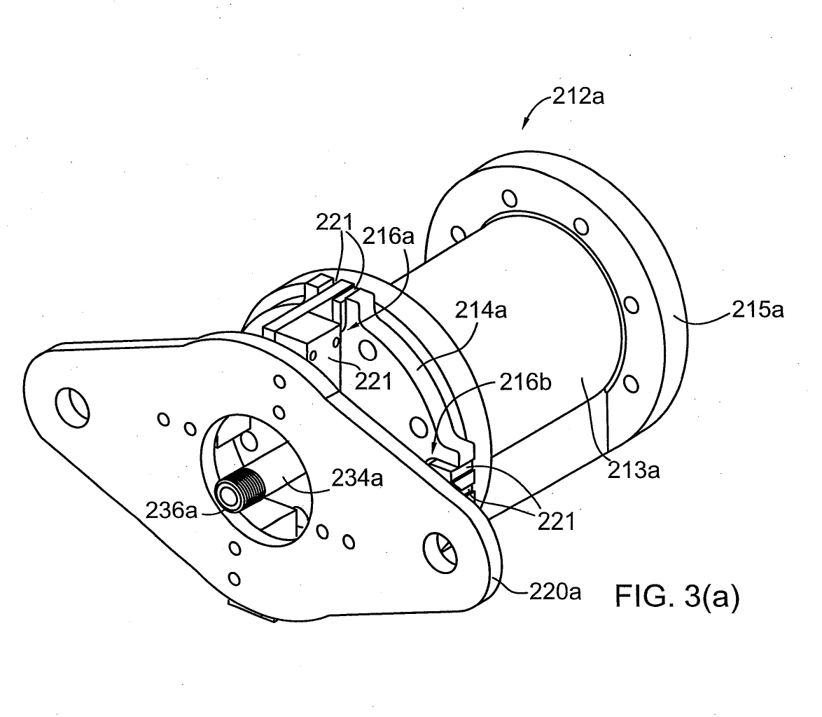

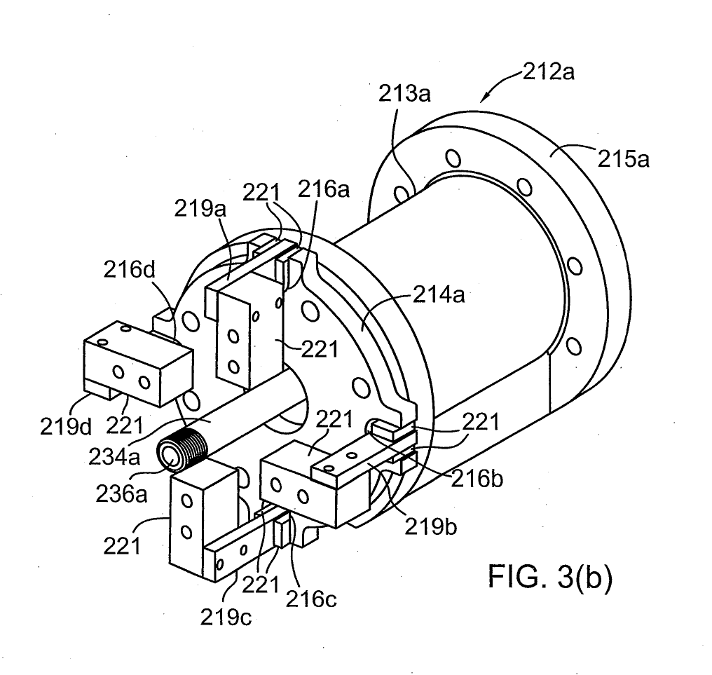

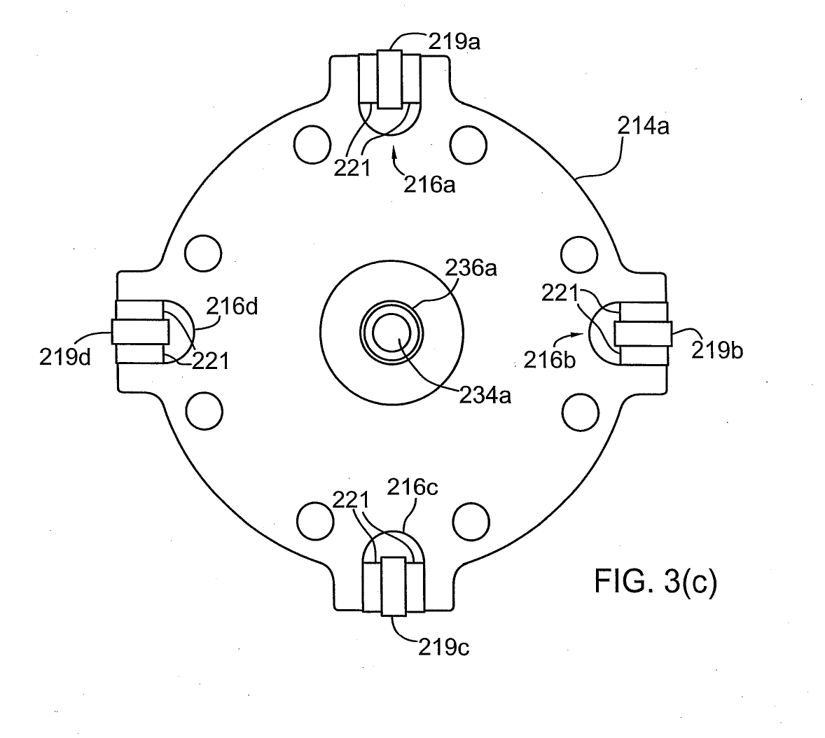

As shown in FIG. 2(a), the cylinder assembly 210 comprises respective cylinder modules 212, indicated individually by references 212a and 212b. The cylinder modules 212 comprise respective cylinder bodies 213a, 213b and cylinder flange covers 214a, 214b which are coupled to the respective ends of the cylinder assembly 210. At the other end, the cylinder modules 212 include respective cylinder flange covers 215a, 215b, which are coupled together with by a spacer or separator component indicated generally by reference 217. As shown in FIG. 2(a) and FIGS. 3(a) to (c), the cylinder flange covers 214 includes a number of slots 216, for example, four slots indicated individually by references 216a, 216b, 216c and 216d in FIGS. 3(a) to 3(c). Each of the slots 216 is configured to receive or mount in each a guide pin or shaft 219, indicated individually by references 219a, 219b, 219c and 219d in FIGS. 3(a) to (c). The guide pins 219 together with respective mounting blocks couple the respective cylinder flange covers 214a, 214b to an end bracket 220 (indicated individually by references 220a and 220b) on the cylinder assembly 110. According to an embodiment, the slots 216 are configured to accommodate expansion, i.e. thermal expansion, of the cylinder modules 212, and include thermal insulators indicated by reference 221, to minimize heat losses from the cylinder assembly 210. The end brackets 220 couple the cylinder modules 212 to the mounting shafts 222. According to an embodiment, the end brackets 220 include mounting sleeves or collars 222 (indicated individually by references 223a and 223b) which fit the mounting shafts 222. According to an embodiment, the mounting collars 223 include a thermal barrier to minimize heat losses from the cylinder assembly 210. As shown in FIGS. 2(a) and 2(b), the cylinder assembly 210 can also side mounting brackets 224, indicated individually by references 224a and 224b, with each having a pin 225 configured for securing or mounting the spacer component 217 to the support frame 220. The side mounting brackets 224 are located along the side of cylinder assembly 210, example, at a midway point. According to an embodiment, the side mounting brackets 224 include or incorporate a thermal barrier to minimize heat losses from the cylinder assembly 210. The configuration of the parallel mounting shafts 222 provides an arrangement that facilitates the mounting of other components of the system, such as the electromagnetic coil assemblies.

Reference is next made to FIG. 2(b), which shows the cylinder assembly 210 in more detail in a sectional view taken along line A-A. According to an embodiment, each of the cylinder modules 212 include a respective piston indicated by references 231 and 232. The pistons 231, 232 are configured in a coaxial or in-line arrangement. As described above for the cylinder assembly 110 (FIGS. 1(a) to 1(b)), the movement of the pistons 231, 232, for example due to thermal expansion, is equal but in opposing directions. Each of the pistons 231, 232 is coupled or connected to a respective linear drive shaft or piston rod 234, indicated individually by references 234a, 234b. As shown, each of the linear drive shafts 234 includes a coupler or connector 236, indicated individually by references 236a and 236b, which is configured to connect to respective inductive elements 49, indicated individually by references 49a and 49b. According to an embodiment, the inductive element 49 may comprise a magnet which induces a voltage in a coil in response to movement of the piston, as described in more detail below.

As shown in FIG. 2(b), the cylinder module 212a includes a first input/output port 240a and a second input/output port 240b. The first input/output port 240a is in communication with a chamber 246 formed between the piston 231 and the spacer 217. The second input/output port 240b is in communication or coupled to a chamber 247 formed between the piston 231 and the cylinder flange cover 214a. Similarly, the cylinder module 212b includes a first input/output port 242a and a second input/output port 242b. The first input/output port 242a is in communication with or coupled to a chamber 248 formed between the piston 232 and the spacer 217. The second input/output port 242b is in communication with or coupled to a chamber 249 formed between the piston 232 and the cylinder flange cover 214b. According to an embodiment, the cylinder assembly 212a includes a rebound device 250a in the chamber 247. The rebound device 250a is configured to repel or push back the piston 231 and prevent the piston 231 from contacting the end wall of the chamber 247 as it travels within the chamber 247 toward the cylinder flange cover 214. According to an embodiment, the rebound device 250a comprises a magnet or magnetic device which repels the moving piston 231. Similarly, the second cylinder module 212b includes a respective rebound device 250b which is configured to repel the piston 232.

According to an embodiment and as shown in FIG. 2(b), each of the input/output ports 240, 242 is coupled or connected to a respective flow control switch 241, 243 indicated individually by references 241a, 241b and 243a, 243b. According to an embodiment, the flow control switches 241, 243 are configured as close as possible to the respective input/output ports 240, 242 to minimize the formation of parasitic volume(s). The flow control switches 241, 243 are coupled to a gas or vapour (or heated liquid source) and operate under the control of a controller, for example, through stepper motors controlled by a controller (e.g. microprocessor) operating under stored program control. The controller is configured to open and close the flow switches 241, 243 in synchronization or sequence so that gas or vapour is injected and exhausted from the respective chambers to cause the pistons 231, 232 to move in a linear cycle and drive the respective inductive components 49, for example, as indicated by arrows 50a and 50b, through the electromagnetic coil assemblies to generate electrical energy, as will be described in more detail below. According to an embodiment, each of the pistons 231, 232 or drive shafts can include a motion sensor (e.g. a laser motion sensor) to monitor the position of the piston and provide a location reading that can be used to further control operation of the linear generator 200. According to an embodiment, a gas is injected into each of the chambers 246 and 248, and expansion of the gas forces the pistons 231, 232 to move away from each other and outwardly into the respective chambers 247 and 249. The two rebounding devices 250 act to force the pistons 231, 232 back to their starting positions, and through the operation of the flow valves 240a, 240b energy can be recovered from the respective chambers 247 and 249. The exemplary operation of the linear generator 200 in a power generation application and according to an embodiment of the invention is described in more detail below.

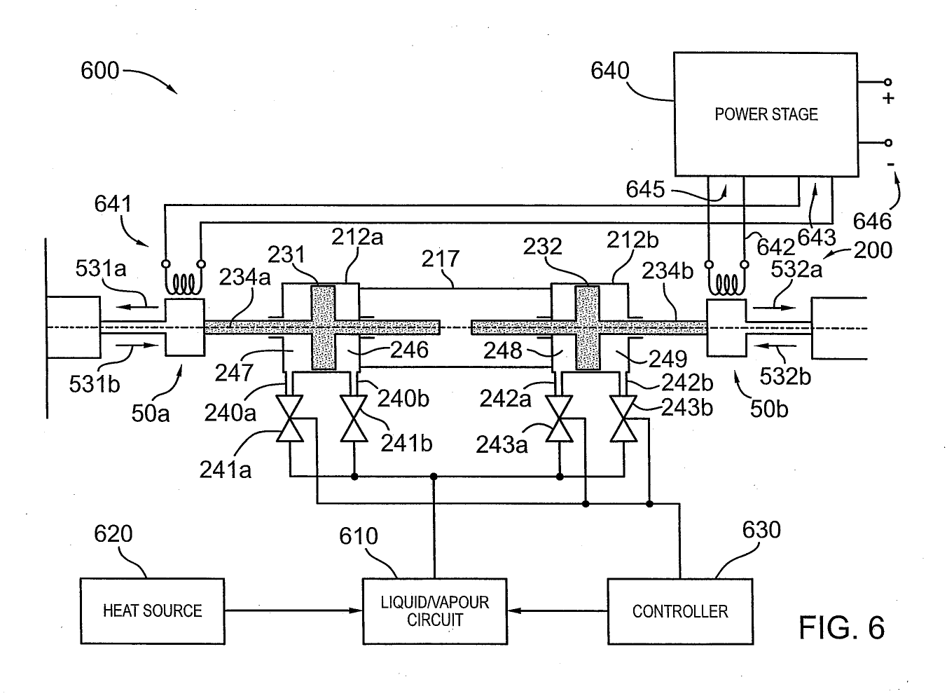

Reference is next made to FIG. 6, which shows an exemplary power generating application according to an embodiment of the invention utilizing the linear power generator 200 and indicated generally by reference 600. According to an embodiment, the power generator application 600 comprises a liquid/vapour circuit 610, a heat source 620, a controller 630 and a power stage 640. The linear power generator 200 comprises the configuration described above with reference to FIGS. 2(a) to 2(b) and FIGS. 3(a) to 3(c), and like reference numerals indicate like elements. As shown, the input/ports 240 and 242 are coupled to the vapour circuit 610 via the respective flow-switches 241 and 243. As shown, the vapour circuit 610 also includes an input for receiving heat energy from the heat source 620. The control inputs of the flow-switches 241 are coupled to a control port or ports on the controller 630. As also shown, the power stage 640 includes a first inductive coil 641 which is coupled to a first input port 643 and a second inductive coil 642, which is coupled to a second input port 645. According to an embodiment, the heat source 620 comprises a low grade or waste heat source, for example, configured for an internal combustion engines, HVAC equipment, electric motors and generators.

According to an embodiment, the liquid/vapour circuit 610 comprises a vapourizer, an expander, a condenser and a liquid reservoir configured in a vapour-liquid heat transfer circuit. The vapour circuit 610 is configured is to produce a gas or vapour which is outputted to the linear generator 200 via the flow control switches 241b and 243b and under the control of the controller 630 used to generate forces to actuate the linear power generator 200 and generate electrical power as described in more detail below. According to an embodiment, the reservoir is configured as a holding tank for a fluid or condensate, for example, a suitable Freon gas. The vapourizer includes a heat exchanger and is configured to receive low grade or waste heat from the heat source 620. The vapourizer receives fluid or condensate from the reservoir which is converted into a gas or vapour through application of the heat from the heat source 620. The resulting gas or vapour is applied to the respective chamber 246, 248 for the pistons 231, 232 of the linear power generator 200 via the flow switches 241, 243 operating under the control, of the controller 630. This results in forces that drive the pistons 231, 232 in opposite directions and thereby move the inductive elements 49a, 49b across the respective coils 641, 642 as indicated by arrows 631a and 632a. As the pistons 231, 232 approach the end of the chambers 247, 249, the rebound devices 250a, 250b function to slow down and reverse the direction of the respective pistons 231, 232 and cause the respective coils 641, 642 to move back in the directions as indicated by arrows 631b and 632b, i.e. to complete a linear cycle. According to an embodiment, the inductive elements 50a and 50b comprise magnets or a magnetic coil and the movement of the inductive elements 50a, 50b induces a voltage in the respective coils 641, 642. The power stage 630 is configured to condition or otherwise process the outputs from the coils 641, 642 and produce an output at an output port 646. According to an embodiment, the power stage 630 is configured to rectify the output voltages from the coils 50a, 50b produce a DC voltage output at the output port 646.

Referring again to FIG. 6, the controller 630 is configured according to an embodiment with one or more microprocessors or microcontrollers or similar programmable control devices. The microprocessor(s) in the controller 630 operate under stored program control (for example, execute instructions, executable code, programs or code modules in the form of firmware or software stored in memory) to sequentially control the opening and closing of the flow control switches 241, 243 and the routing of vapour to/from the respective chambers 246, 247 and 248, 249 to/from the vapour circuit 610 in synchronization with the movement of the pistons 231, 132, and provide the other functionality and/or operational characteristics as described herein.

Reference is next made to FIG. 4, which shows in flowchart form a control process according to an embodiment and indicated generally by reference 400. The control process 400 comprises a process for monitoring piston movement or stroke in the cylinder modules 212 and controlling the pressures in the respective chambers through the actuation of the flow switches 241, 243. According to an embodiment, the control process 400 and associated functionality is implemented in the controller 530, for example, in the form of a microprocessor operating under stored program control.

As shown in FIG. 4, the control process 400 comprises a first control loop or branch 410 which monitors the speed of the two pistons 231, 232 (FIG. 2(b)) and adjusts the speed of the pistons 231, 232 through the injection/exhaust of gas/vapour into the respective chambers 246, 247 and 248, 249 (FIG. 2(b)). As shown, the first operation indicated by step 411 comprises monitoring the movement or stroke of the first (e.g. left) piston 231 and the second (e.g. right) piston 232, for example, using motion sensors, and determining for example, an operating frequency or a speed parameter for each of the pistons 231, 232. The next operation, indicated by step 412, comprises comparing the strokes (e.g. operating frequencies) of the pistons 231, 232 and determining whether the pistons 231, 232 are moving at substantially the same speed or frequency. It will be appreciated that to reduce vibration or improve efficiency, the pistons 231, 232 should be operated at substantially the same speed or substantially in synchronization. If there is a difference between the strokes of the first 231 and second 232 pistons (as determined in step 412), the controller 630 is configured to adjust the speed of the first piston 231 as indicated by step 414, or adjust the speed of the second piston 232 as indicated by step 416, or adjust the speed of both pistons 231, 232. As described above, the pistons 231, 232 move in response to gas or vapour being injected into the respective chambers 246, 248 through the input/output ports 240a, 242a under the control of the associated flow control switches 241a, 243a. According to an embodiment, each of the flow control switches 241, 243 comprises a solenoid type valve and is coupled to a stepper motor or other actuator, which is responsive to one or more control signals from the controller 630 for opening/closing the respective flow control switches, and thereby regulate the gas injected/exhausted from the respective chambers. In this manner, a pressure differential is created across each of the pistons 231, 232 in order to move or drive the piston in the desired direction. According to another aspect, the movement of the first 231 and the second 232 pistons is synchronized through the generation or application of the control signals by the controller 630 so that each piston is moving in substantially opposite directions at substantially the same time in order reduce vibrations and/or increase the operating efficiency of the generator. According to this embodiment, the speed of one or both of the pistons 231, 232 is regulated or adjusted.

As shown in FIG. 4, the control process 400 includes another control loop indicated generally by reference 420. The control loop 420 comprises a process or control algorithm for determining maximum pressure Pₘₐₓ and minimum pressure Pₘᵢₙ values and obtaining an optimum operating frequency. The first operation, as indicated by step 421, comprises determining a maximum pressure Pₘₐₓ value and a minimum pressure Pₘᵢₙ value for each of the chambers 246, 247 and 248, 249. According to an embodiment, pressure readings are taken using appropriate sensors for each stroke of the pistons 231, 232. The next operation, as indicated by step 422, comprises calculating a process pressure value, i.e. (Pₘₐₓ−Pₘᵢₙ)_{process}. The next operation, as indicated by step 424, involves obtaining an optimum operating frequency for the process pressure value. According to an embodiment, the operating frequency determination can be made using a function, or according to another embodiment, the determination can be made using a lookup table configured in memory accessible by the controller 630. If the operating frequency is not at the optimum operating frequency, then the controller 630 is configured to adjust the operating pressures in the respective chambers. As described above, in order to move the first piston 231 outwardly (i.e. in the direction of arrow 531a (FIG. 6), the input/output port 240b is controlled to achieve a higher pressure in the chamber 246 than the pressure in the chamber 247 which is controlled by the input/output port 240a. In order to move the first piston 231 inwardly (i.e. in the direction of arrow 53 lb (FIG. 6), the input/output port 240a is controlled to achieve a higher pressure in the chamber 247 than the pressure in the chamber 246 which is controlled by the input/output port 240b, for example, actuated to exhaust gas from the chamber 246. The second piston 232 is actuated in a similar manner to provide movement in the direction of arrows 532a and 532b (FIG. 6).

According to an embodiment, the control loop 420 includes a control sequence for controlling the high pressure header (i.e. the chamber and valve for initiating and driving the piston in a given direction). It will be appreciated that the chambers will alternate between high pressure and low pressure headers in order to allow the bidirectional movement of the pistons. The high pressure header control is indicated generally by reference 430, and comprises determining if the pressure in the high pressure header is greater than or less than the target pressure value as indicated by step 431. The target pressure value corresponds the maximum pressure for obtaining the optimum operating frequency. If the detected operating pressure is greater than the target pressure value (as determined in step 431), then the controller 630 is configured to actuate the associated flow switch control to exhaust gas from the input/output port as indicated by step 432 and thereby reduce the pressure in the high pressure header, i.e. the higher pressure chamber. On the other hand, if the detected operating pressure is less than the target pressure value (as determined in step 431), then the controller 630 is configured to actuate the associated flow-switch control to add gas through the input/output port as indicated by step 434 and thereby increase the pressure in the high pressure header, i.e. the higher pressure chamber.

According to an embodiment, the control loop 420 also includes a control sequence for controlling the low pressure header (i.e. the chamber and valve with the lower pressure for allowing the piston to move in a given direction). The low pressure header control is indicated generally by reference 440, and comprises determining if the pressure in the low pressure header is greater than or less than the target pressure value as indicated by step 441. The target pressure value corresponds the minimum pressure for obtaining the optimum operating frequency. If the detected operating pressure is greater than the target pressure value (as determined in step 441), then the controller 630 is configured to actuate the associated flow-switch control to exhaust gas from the input/output port as indicated by step 442 and thereby reduce the pressure in the low pressure header, i.e. the chamber at the lower pressure. On the other hand, if the detected operating pressure is less than the target pressure value (as determined in step 441), then the controller 630 is configured to actuate the associated flow-switch control to add gas through the input/output port as indicated by step 444 and thereby increase the pressure in the low pressure header, i.e. the low pressure chamber.

While the cylinder assembly 110 in FIG. 1 or the cylinder assembly 210 in FIG. 2 have been described with a dual module or piston configuration. It will however be appreciated that a reciprocating configuration can be configured with more than two pistons or cylinder modules. For example, according to an embodiment, the cylinder components 112 or 212 can be configured with more than one piston provided the forces generated in the cylinders are substantially the same (and opposite) to reduce or offset the resulting vibrations.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A linear power generator comprising:
a cylinder assembly;
an electromagnetic coil;
said cylinder assembly comprising a first piston and a second piston configured in a substantially co-axial arrangement, said first piston being configured to move in a first direction in response to application of a pressurized gas, and said second piston being configured to move in a second direction in response to application of a pressurized gas, and said second direction being substantially opposite to said first direction;
a first drive shaft coupled to said first piston at one end and having another end configured for coupling to an electromagnetic component, and said first drive shaft being configured to move said electromagnetic component in relation to said electromagnetic coil in response to movement of said first piston so as to induce a voltage in said electromagnetic coil;
a second drive shaft coupled to said second piston at one end and having another end configured for coupling to an electromagnetic component, and said second drive shaft being configured to move said electromagnetic component in relation to said electromagnetic coil in response to movement of said second piston so as to induce a voltage in said electromagnetic coil; and
a first rebound mechanism configured to move said first piston back to a starting position, and a second rebound mechanism configured to move said second piston back to a starting position.

2. The linear power generator as claimed in claim 1, wherein said pressurized gas is generated using a waste or low grade heat source.

3. The linear power generator as claimed in claim 2, wherein said low grade heat source comprises one or more of heat captured from a combustible fuel engine, electric motor or generator, an HVAC system, waste heating fluid, and a geothermal heat source.

4. The linear power generator as claimed in claim 1, wherein said cylinder assembly comprises a first chamber configured for said first piston, and a second chamber configured for said second piston, said first and said second chambers being configured in a coaxial arrangement, and said first chamber includes a first input port for inputting said pressurized gas and a first output port for exhausting gas from said first chamber, and said second chamber includes a second input port for inputting said pressurized gas and a second output port for exhausting gas from said second chamber.

5. The linear power generator as claimed in claim 4, wherein said first input port and said second input port comprise a common input port for said first and said second chambers, and said cylinder assembly includes a spacer dividing said first and said second chambers.

6. The linear power generator as claimed in claim 4, further including a first bidirectional valve switch coupled to said first input port and configured for controlling flow of the pressurized gas into said first input port in response to a control signal, and a second bidirectional valve switch coupled to said second input port and configured for controlling flow of the pressurized gas into said second input port in response to a control signal.

7. The linear power generator as claimed in claim 6, further including a third bidirectional valve switch coupled to said first output port and configured for controlling flow of the pressurized gas through said first output port in response to a control signal.

8. The linear power generator as claimed in claim 7, further including a fourth bidirectional valve switch coupled to said second output port and configured for controlling flow of the pressurized gas through said second output port in response to a control signal.

9. The linear power generator as claimed in claimed in claim 7, further including a controller having a controller component configured for generating control signals to actuate said first and said third bidirectional valve switches to generate a first pressure differential to move said first piston in said first direction and a second pressure differential to move said first piston to said starting position.

10. The linear power generator as claimed in claim 9, wherein second pressure differential augments the force created by said first rebound mechanism.

11. The linear power generator as claimed in claim 9, wherein first rebound mechanism comprises said second pressure differential.

12. The linear power generator as claimed in claimed in claim 8, further including a controller having a controller component configured for generating control signals to synchronously actuate said first and said third bidirectional valve switches to create a first pressure differential to move said first piston in said first direction and a second pressure differential to move said first piston to said starting position and to synchronously actuate said second and said fourth bidirectional valve switches to generate a second pressure differential to move said second piston in said second direction and a second pressure differential to move said second piston to said starting position, and wherein said control signals are substantially synchronized so that said first piston and said second piston move in substantially opposite directions at substantially the same time.

13. The linear power generator as claimed in claim 4, further including a support frame having one or more brackets for mounting said cylinder assembly and said electromagnetic coil.

14. The linear power generator as claimed in claim 13, wherein said support frame is configured to mount said cylinder assembly and said electromagnetic coil in a coaxial arrangement, and said electromagnetic coil comprises a first coil component mounted at one end of said cylinder assembly and a second coil component mounted at another end of said cylinder assembly.

15. A method for generating power from a linear power generator utilizing a waste heat source, said method comprising the steps of:
utilizing heat from the waste heat source to generate a pressurized vapour;
applying a portion of said pressurized vapour to move a first piston in a linear cycle, and applying a portion of said pressurized vapour to move a second piston in a linear cycle, wherein movement of said first piston during said linear cycle is substantially opposite in direction to movement of said second piston during said linear cycle, and said first piston including a drive shaft with an electromagnetic component and said second piston including a drive shaft with an electromagnetic component;
moving said first electromagnetic component and said second electromagnetic component through an electromagnetic coil during at least a portion of said linear cycles to induce a voltage in said electromagnetic coil; and
reversing movement of said first piston during said linear cycle to return said first piston to a starting position, and reversing movement of the second piston during said linear cycle to return said second piston to a starting position.

16. The method as claimed in claim 15, wherein said step of reversing movement of said first piston and said second piston comprises applying a magnetic rebounding force to said pistons.

17. The method as claimed in claim 16, wherein said step of applying a portion of said pressurized vapour comprises applying a pressure differential to move said first and said second pistons in respective first directions during said linear cycle.

18. The method as claimed in claim 17, wherein said step of reversing movement of said first and said second pistons comprises applying opposite pressure differentials to move said first and said second pistons in respective opposite directions during said linear cycle.

19. The method as claimed in claim 17, wherein the application of said pressure differentials to move said first and said second pistons is synchronized to move said first and said second pistons at substantially the same time during said linear cycles.

20. The method as claimed in claim 18, wherein the application of said pressure differentials to move said first and said second pistons is synchronized to move said first and said second pistons at substantially the same time during said linear cycles.
